(19) United States
(12) Patent Application Publication
(10) Pub. No.: US 2002/0097864 A1
(43) Pub. Date: Jul. 25, 2002

(54) Method for echo cancellation

(76) Inventors: Per Ljungberg, Lund (SE); Mats Erixon, Bjarred (SE)

Correspondence Address: JENKENS & GILCHRIST, PC, 1445 ROSS AVENUE, SUITE 3200, DALLAS, TX, 75202, US

(21) Appl. No.: 09/767,311

(22) Filed: Jan. 23, 2001

(51) Int. Cl. H04M 9/08; H04B 1/38

(52) U.S. Cl. 379/406.01; 455/570

(57) ABSTRACT

A method and apparatus for canceling noise in a communication device is disclosed. Impulse responses to a mechanical non-linear echo in an echo-free environment are measured prior to an initial use of a communication device. A plurality of high energy parameters from these responses are extracted. A mean value of these parameters is computed and pre-stored in non volatile memory of the communication device during production of the device. During an initial use of the communication device, the pre-stored values are downloaded to the static DSP RAM and used to offset the non-linear echo.

### FIELD OF THE INVENTION

This invention relates to improved quality in communications and more particularly, to a method of echo cancellation in a mobile communication device.

### BACKGROUND OF THE INVENTION

The success of mobile communication devices such as cellular phones has been well documented. Designers and manufacturers strive constantly to add increased functionality to these devices. One feature that is being added is the ability to use a communication device in a “hands-free” mode. In this mode, a user of a communication device need not hold the device in his or her hand. The hands-free mode enables an individual to perform other functions, such as driving, while simultaneously using the telephone. One method of achieving this goal is to use a headset connected to the communication device which may be plugged into a user's ear for listening and having a microphone positioned proximal to a user's mouth for talking into the phone. Another way to achieve the “hands-free” operation is the use of an amplification means (such as a speaker, for example) for listening or receiving audio output and a microphone for talking or inputting the user's audio input. A communication device 100 is illustrated in FIG. 1 with a speaker 110 and a microphone 140.

Speaker phones, however, possess certain undesirable characteristics. One of these characteristics is the presence of an “echo” 120, 130 of FIG. 1 from the speaker 110. The echo is in the form of an acoustic or structural wave that interferes with microphone input 140. A listener on the other end experiences a degradation in the quality of the communication as a result of this echo.

Echoes may be one of two types: a linear echo 120 and a non-linear echo 130. Linear echoes, as illustrated in FIG. 1, originate from the surroundings of the communication device. Sound from the speaker propagates through the surroundings of the communication device and reflects off a reflecting surface or object 150 (such as a wall, for example) and arrives at the microphone 140. Existing echo cancellation methods function adequately in dealing with linear echo.

A linear echo path tracking filter operates in an adaptive manner. This filter is updated adaptively to track changes in an echo path. The tracking is performed by updating a plurality of filter coefficients which are stored in a static DSP RAM within the communication device. Since the medium in which these coefficients are stored is static, the coefficient values are available from one phone call to the next phone call. There is also a high probability that each time a communication device is used, it is used in a very similar environment as the last time it was used. Therefore, the amount of adaptation required by the echo canceling filter is low. When the communication device is powered down, the most significant filter coefficients are downloaded to non-volatile memory. Upon powering on of the device the next time, these taps are downloaded to the DSP RAM which, through repeated use of the device, leads to the filter adapting itself to the environment in which it operates. During an initial use of the communication device, the filter may take between one and two seconds to adapt to the linear echo. The echo is most severe the first time a speaker phone is used.

The second type of echo, the non-linear echo 130 of FIG. 1, may originate from a mechanical non-linear echo path inside a communication device such as a cellular phone. This type of echo is, in some situations, much stronger than the linear echo. When encountering non-linear echo, the linear echo canceling filter approximates the non-linear echo path with a linear impulse response.

An echo cancellation apparatus 200 that is updated adaptively to track changes in an echo path is illustrated in FIG. 2. The apparatus includes a speech decoder 210 for decoding a received signal 205. The decoded signal 215, in digital form, is converted to an analog signal 225 by the D/A converter 220 and processed by the speaker 230. A non-linear echo 235 and linear echo 240 is formed by the output of the speaker. The two types of echo are received by the microphone 245. The output of the microphone 250, in analog form, is converted to a digital signal 260 by the A/D converter 255. The linear adaptive filter 270 attempts to estimate a total impulse response hₗᵢₙ+hₙₒₙₗᵢₙ. An algorithm for updating the adaptive filter 270 may be the LMS (least means square) algorithm. The speaker signal 215 is input into the filter 270. The output 265 of the filter is subtracted from the digital microphone signal 260. In an ideal situation, the subtraction results in a zero difference. In reality, however, a difference exists between the filter output 265 and the digital microphone signal 260. The difference 275 is fed back into the filter in order for the filter 270 to determine coefficients hₑₛₜ that more closely approach the total impulse response. The difference 275 is encoded by a speech encoder 280 prior to transmission.

This approximation (of a non-linear echo) is usually a tedious and time-consuming process for the linear filter. As a result, an initial user of the communication device with a speaker phone is forced to tolerate strong echoes until the filter has adapted to the non-linear echo path. This process may often take between 30 and 60 seconds. Users encountering this situation often assume that the communication device is defective and may not use the speaker phone feature, seek service help or in worse cases, return the device to the manufacturer as being defective.

The linear echo path canceling filter has the ability to adapt to the non-linear echo path by saving the most significant filter coefficients to non volatile memory at powering down and subsequently downloading the saved values to provide a better start value for adaptive tracking. The problem, as described, is with the initial communication utilizing the speaker phone functionality since no previous data from the non-linear echo path is available.

What is desired, therefore, is a method and apparatus for negating the effects of a non-linear echo path in a mobile communication device having a speaker phone functionality during the use of the communication device.

### SUMMARY OF THE INVENTION

Accordingly, an object of the present invention is to provide an apparatus and a method for overcoming the limitations described above.

Another object of the present invention is to provide an apparatus and a method for canceling echo in a communication device.

A further object of the present invention is to provide an apparatus and method for canceling a non-linear echo in a communication device.

A yet another object of the present invention is to provide an apparatus and method for canceling a non-linear echo stemming from a mechanical nature of the communication device.

These and other objects of the present invention are achieved by pre-storing a plurality of parameters in a communication device during manufacture of the device. The parameters represent the mechanical responses of the communication device to non-linear echo. The pre-stored parameters are downloaded upon an initial use of the communication device and utilized to offset non-linear echo experienced by the communication device.

### BRIEF DESCRIPTION OF THE DRAWINGS

Objects and features of the present invention will be more apparent from the following description and reference to the accompanying drawings, wherein:

FIG. 1 illustrates a communication device with a speaker phone capability and a plurality of echo paths;

FIG. 2 illustrates an echo canceling apparatus;

FIGS. 3(a)-3(c) illustrate impulse responses for a plurality of similar communication devices with speaker phone functionality; and

FIG. 4 illustrates a method according to exemplary embodiments of the present invention.

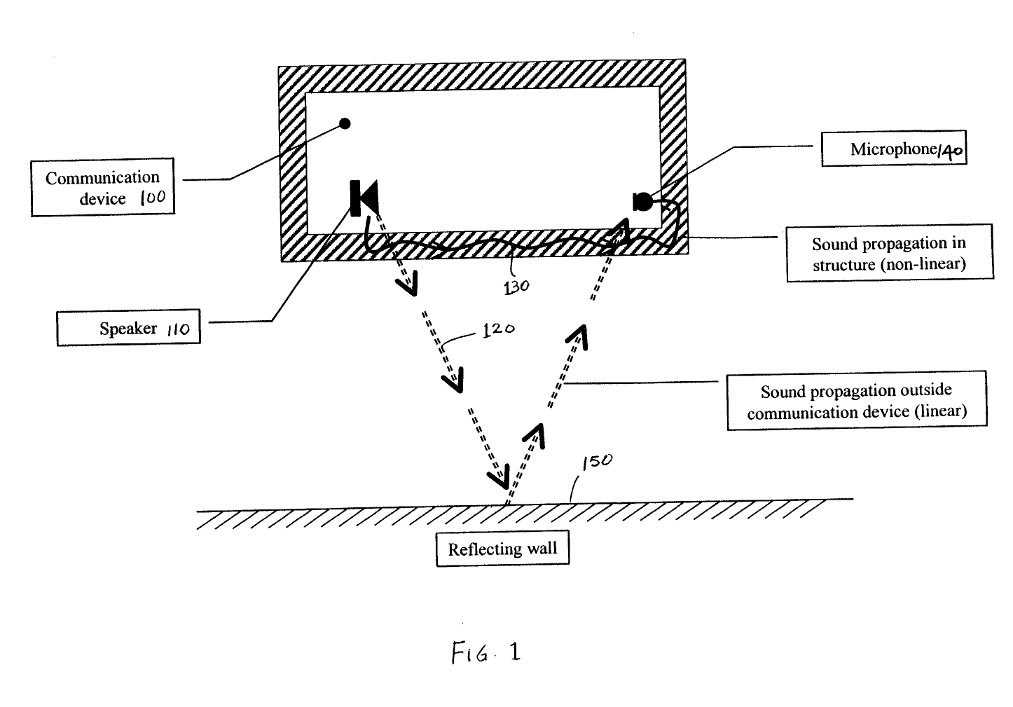

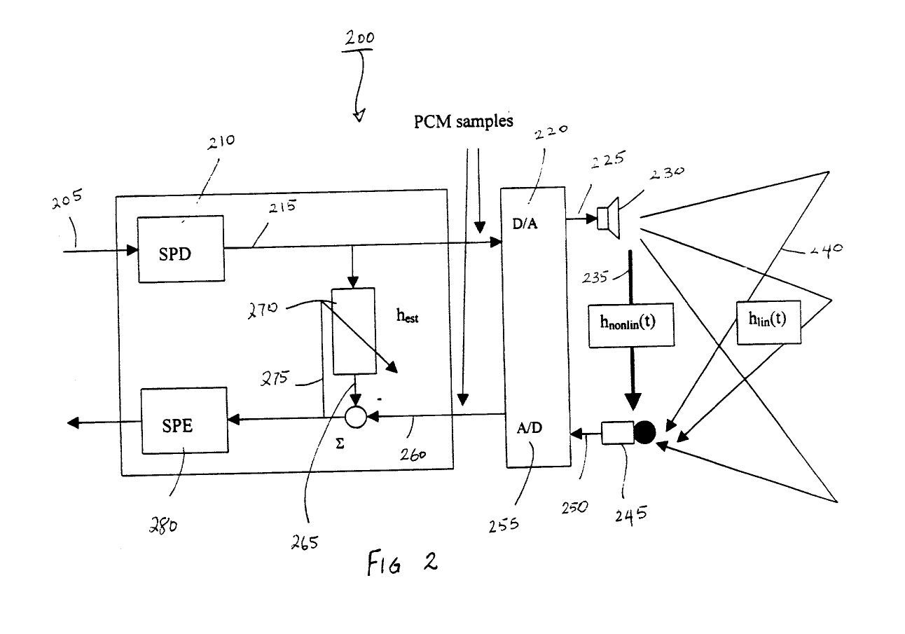

### DETAILED DESCRIPTION

In the following description, for purposes of explanation and not limitation, specific details are set forth, such as particular circuits, circuit components, methods, techniques, etc. in order to provide a thorough understanding of the present invention. However, it will be apparent to one skilled in the art that the present invention may be practiced in other embodiments that depart from these specific details. In other instances, detailed descriptions of well-known methods, circuits and circuit components are omitted so as not to obscure the description of the present invention.

Experimental tests on a plurality of identical communication devices (such as the same model phone) with speaker phone functionality in an echo-free environment (i.e., linear echo free) have revealed that the impulse responses of these devices remained uniform and consistent. Real speech, such as that which may be encountered by the communication device during usage, was introduced into the speaker path and the corresponding echo was measured. Since the tests were performed in an echo-free environment, the echo encountered by the device was solely the mechanical non-linear echo. The impulse response corresponding to the coefficients of the adaptive filter was obtained by using the speaker phone functionality of the communication device until this echo (i.e., non-linear echo) was eliminated and the device was powered down. At this time, the most significant filter coefficients identified above were stored in non volatile memory. These values (i.e., stored in memory) were then analyzed by an external computer.

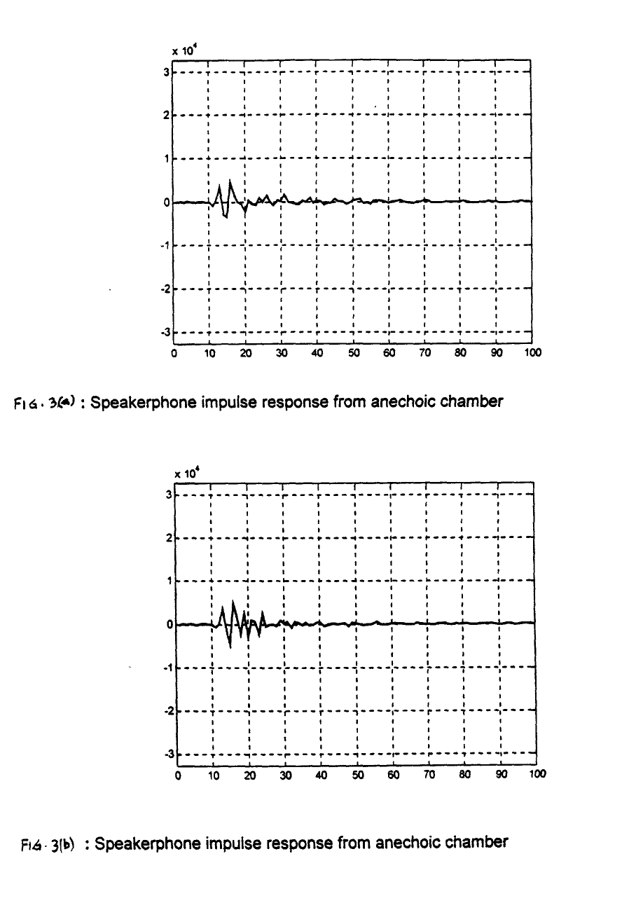

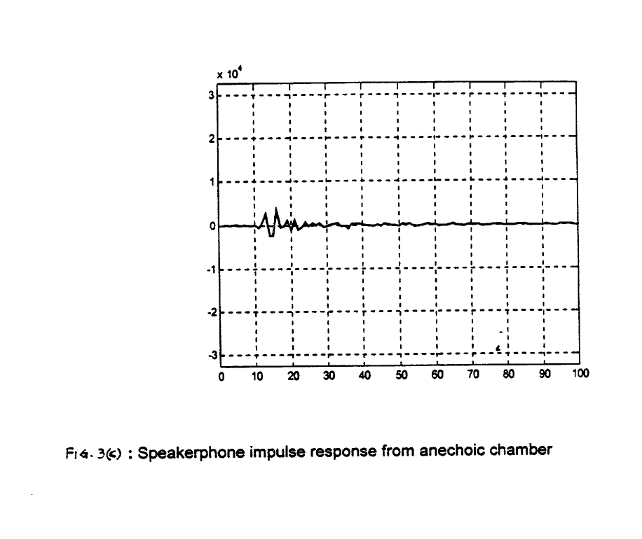

The similarity of the impulse responses is noticeably stronger for the high-energy coefficients between a particular range of samples (in this case, between the 10^{th} and the 20^{th} samples) as illustrated in FIGS. 3(a)-3(c) in which the vertical axis represents amplitude that is proportional to the square root of the energy and the horizontal axis represents time. It should be noted that these impulse responses correspond to a specific mechanical construction of the communication device. Another mechanical construction may yield a different impulse response. Such factors as the material used to construct the device, coupling between various elements within the device, design, shape and layout of the device may all potentially contribute to and alter the type of non-linear echo.

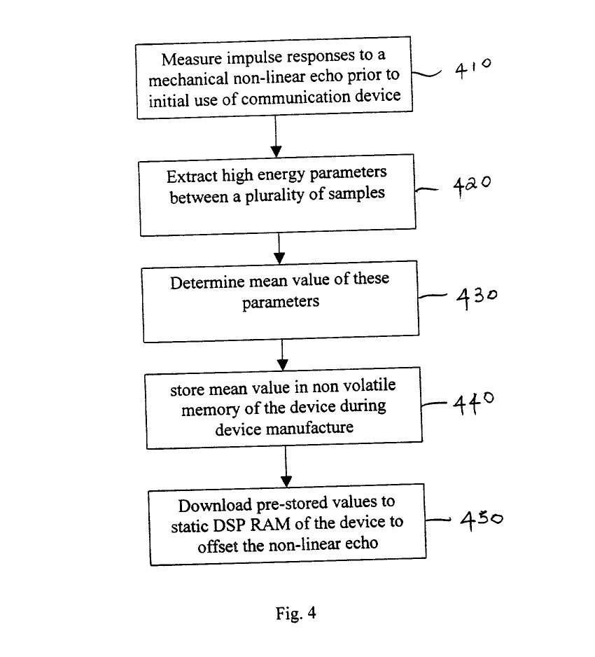

According to exemplary embodiments of the present invention, as illustrated by the flow of chart of FIG. 4, impulse responses to a mechanical non-linear echo are measured in an echo-free environment at step 410 prior to an initial use of the communication device with speaker phone capability. This may be performed after manufacture but before packaging and distribution of the product for sale. The high energy parameters, which are concentrated between a plurality of samples (such as between the 10^{th} and 20^{th} samples in the illustrated case), are extracted at step 420. A mean value of these parameters is determined at step 430 and pre-stored in a non volatile memory of the communication device at step 440.

Upon an initial powering on of a communication device (by a consumer, for example), the pre-stored values are downloaded to static DSP RAM and are then utilized as start values for the linear echo cancellation filter to offset the non-linear echo at step 450.

The foregoing has described the principles, preferred embodiments and modes of operation of the present invention. However, the invention should not be construed as being limited to the particular embodiments described above. For instance, while the foregoing has described exemplary methods of the present invention as applied to a communication device with an amplification functionality such as a speaker phone, it should be noted that the present invention may equally be applied to a communication device with a receiver (such as a handheld receiver for example) that does not have a speaker phone. Therefore, the above-described embodiments should be regarded as illustrative rather than restrictive, and it should be appreciated that variations may be made in those embodiments by those skilled in the art without departing from the scope of the present invention as defined by the following claims.

What is claimed is:

1. A method of offsetting non-linear echo in a communication device having a speaker phone capability, comprising the steps of:
measuring a plurality of impulse responses of the communication device in an anechoic chamber;
extracting a predetermined number of high-energy parameters from the plurality of measurements;
pre-storing said parameters in a non-volatile memory of said communication device.

2. The method of claim 1, wherein said communication device is a mobile telephone.

3. The method of claim 1, wherein said device further comprises an adaptive filter.

4. The method of claim 1, wherein said responses are responses to a mechanical echo from said communication device.

5. The method of claim 1, wherein said pre-stored parameters are downloaded to a non-volatile memory of said communication device upon an initial use of said device.

6. The method of claim 5, wherein said downloaded parameters are used to offset a non-linear echo within said communication device.

7. A communication device, comprising:
an output means for outputting data received by said device;
an input means for receiving input from a user;
an antenna means for enabling said reception and a transmission of said user input; and
a non-volatile memory means for storing a plurality of parameters, wherein said parameters represent impulse responses measured in an anechoic chamber.

8. The device of claim 7, wherein said output means is a speaker.

9. The device of claim 7, wherein said input means is a microphone.

10. The device of claim 7, wherein said responses are responses to a mechanical echo from the communication device.
